(19) United States
(12) Patent Application Publication
(10) Pub. No.: US 2006/0013503 A1
(43) Pub. Date: Jan. 19, 2006

(54) Methods of preventing noise boost in image contrast enhancement

(75) Inventor: Yeong-Taeg Kim, Irvine, CA (US)

Correspondence Address: MYERS DAWES ANDRAS & SHERMAN, LLP, 19900 MACARTHUR BLVD.,, SUITE 1150, IRVINE, CA, 92612, US

(73) Assignee: Samsung Electronics Co., Ltd., Suwon City (KR)

(21) Appl. No.: 10/892,775

(22) Filed: Jul. 16, 2004

(51) Int. Cl. G06K 9/36

(52) U.S. Cl. 382/276

(57) ABSTRACT

An adaptive contrast enhancement method and device provide video signal contrast enhancement with reduced noise amplification. The video signal has a plurality of temporally ordered digital pictures, each one of the digital pictures represented by a set of samples, wherein each one of the samples has a gradation level. A contrast enhancement transform is constructed for enhancing the contrast of the video signal, and transform ratios are computed based on the contrast enhancement transform. Then the smoothed transform ratios are then applied to a set of samples representing a digital picture to enhance contrast of the digital picture with reduced noise amplification.

### FIELD OF THE INVENTION

The present invention relates generally to video processing, and more particularly to video signal enhancement.

### BACKGROUND OF THE INVENTION

The development of modern digital video technology has brought significant enhancement in the video quality for consumers, such as in DVD players and in digital TVs (DTV) compared to the analog TV systems. However, such digital video systems only enhance the video quality in terms of signal to noise ratio (SNR) and resolution, without regard to other important issues relating to video enhancement. Such issues include contrast enhancement, brightness enhancement, and detail enhancement. Generally, video enhancement processes comprise a collection of techniques that seek to improve the visual appearance of video when displayed. This primarily includes gray level and contrast manipulation, noise reduction, edge crispening and sharpening. Compared to image restoration, video or image enhancement methods neither increase the inherent information content in the data nor require mathematical modeling. The basic principle of video enhancement is to manipulate a given sequence of images so that their appearance on display media can be improved. Because quantifying the criteria for enhancement is difficult, conventional video enhancement techniques are empirical and require interactive procedures to obtain satisfactory results.

Among the techniques for video enhancement, contrast enhancement is important because it plays a fundamental role in the overall appearance of an image to human being. A human being's perception is sensitive to contrast rather than the absolute values themselves. Hence, it is natural to enhance the contrast of an image in order to provide a good looking image to human beings.

Contrast enhancement involves considering the overall appearance of a given image rather than local appearances such as edge crispening or peaking. There are conventional models of contrast enhancement, and some examples include the root law, the logarithmic law, histogram equalization, and Bi-histogram Equalization. Image enhancement by contrast manipulation has been performed in various fields of medical image processing, astronomical image processing, satellite image processing, infrared image processing, etc. For example, histogram equalization is a useful method in X-ray image processing because it enhances the details of an X-ray image significantly to e.g. detect tumors easily.

One common critical drawback of typical contrast enhancement methods is that they tend to amplify the noise in the original images so that the resulting images become more noisy if the original images contain noise. This limits the applications of contrast enhancement algorithms in consumer products such as TV sets, where noise is typically present.

One typical method to deal with the noise when enhancing the contrast of an image is to perform noise reduction prior to contrast enhancement. However, typical noise reduction methods not only suppress the noise but also tend to blur the image details. In other words, performing conventional noise reduction prior to a contrast enhancement can also degrade the quality of a given image as to the image details.

### BRIEF SUMMARY OF THE INVENTION

The present invention addresses the above problems of contrast enhancement systems. It is an object of the present invention to provide a method for not amplifying the visual appearance of noise while enhancing contrast of images without altering the sharpness of the input picture.

In one embodiment of the present invention, an adaptive contrast enhancement method and device provide video signal contrast enhancement with reduced noise amplification. The video signal has a plurality of temporally ordered digital pictures, each one of the digital pictures represented by a set of samples, wherein each one of the samples has a gradation level. A contrast enhancement transform is constructed for enhancing the contrast of the video signal based on a preselected contrast enhancements method such as, but not limited to, histogram equalization Then locally or spatially smoothed transform ratios are computed based on the contrast enhancement transform and applied to a set of samples representing a digital picture to enhance contrast of the digital picture without boosting up the noise in the picture. The contrast transform ratios over a local region of the picture become essentially constant after the spatial smoothing operation such as a low pass filtering over the transform ratios.

In one example, computing a transform ratio for a target sample involves applying the contrast enhancement transform to the values of at least the neighboring samples to obtain transform values, and determining the transform ratio based on the transform values. In another example, computing a transform ratio for a target sample involves applying the contrast enhancement transform to the values of at least the neighboring samples to obtain transform values, and determining the transform ratio based on the neighboring sample values and corresponding transform values.

In another example, computing a transform ratio for a target sample involves applying the contrast enhancement transform to the values of at least the neighboring samples to obtain transform values, an performing a low-pass averaging of the transform values to obtain said transform ratio. Yet in another example, computing a transform ratio for a target sample involves applying the contrast enhancement transform to the values of at least the neighboring samples to obtain transform values, and determining the transform ratio based on the neighboring sample values, the corresponding transform values, and corresponding weighting factors. The weighting factor for each neighboring sample can be a function of the difference in the target sample value and that neighboring pixel value. As such, if the difference between the value of a neighboring sample and the value of the target sample is outside a selected range, then the corresponding weighting factor for that neighboring sample effectively excludes the transform ratio of that neighboring sample from determination of the transform ratio for the target sample.

Applying the transform ratios involves multiplying each sample value of said set of samples with a corresponding transform ratio to enhance contrast of the digital picture with reduced noise amplification.

### BRIEF DESCRIPTION OF THE DRAWINGS

These and other features, aspects and advantages of the present invention will become understood with reference to the following description, appended claims and accompanying figures where:

FIG. 1 is a block diagram of an embodiment of a device for performing a typical adaptive contrast enhancement.

FIG. 2 shows a block diagram of an embodiment of a device for performing the adaptive contrast enhancement method according to the present invention.

FIG. 3 is an example representation of an input picture comprising N×M pixels.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated.

In one embodiment of the present invention provides a method for not amplifying the visual appearance of noise while enhancing contrast of images without altering the sharpness of the input picture. Such method then can be used with any kind of contrast enhancement methods.

In order not to increase or not to amplify the noise visibility, conventionally a noise reduction method is applied before the contrast enhancement is applied. However, that approach typically introduces blurring to the original pictures, which is not desirable in applications in consumer products. According to the present invention, an example contrast enhancement method first computes or constructs a contrast enhancement function (transform function) for a given input picture. In one example, a histogram equalization method constructs a transform function by computing the cumulative density function of the input picture. Once the transform function has been determined, the transform function may then be applied to the value of each pixel in the input picture for enhancing the picture.

For example, assuming I denotes the input digital picture and i(x, y) denotes the value (e.g., gradation level) of the (x, y)^{th} pixel in the input picture I, then ƒ denotes a contrast enhancement transform function in an enhancement operation such as:
E=ƒ(I) (1)
where E denotes the contrast-enhanced output picture.

If the picture I comprises N×M pixels, then relation (1) above implies the following operation:
e(x, y)=ƒ(i(x, y)), for all x=1, 2, . . . , N and y=1, 2, . . . , M (2)
wherein e(x, y) is the value of the (x, y)^{th} pixel in the output picture E. In this example it is presumed, without loss of generality, that i(x, y),e(x, y)∈{0, 1, . . . , L} where L is a pre-determined value depending on the video system. In most video systems, for example, L=255 can be used.

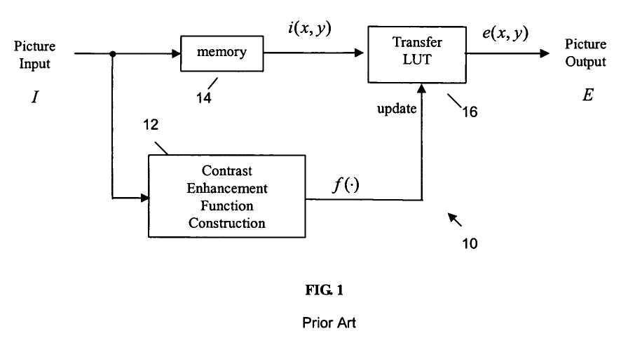

FIG. 1 shows a block diagram of a typical contrast enhancement device 10 that implements an adaptive contrast enhancement method for picture or video enhancement. The device 10 determines the characteristics of a video sequence (e.g., time varying video sequence) and performs a transform (e.g., nonlinear transform) over the input video sequence to enhance mainly the contrast of the input with reduced noise amplification.

In the functional block 12, a contrast enhancement transform function f is determined based on one frame of input picture I, while the input picture I is stored in a memory 14 for matching delay. The constructed enhancement function f is then used in the functional block 16 to update a transform look up table (LUT). The transform LUT represents a mapping table between input and output pixel values associated with the constructed contrast enhancement transform function f. The transform LUT is then used in the functional block 16 to be applied to the input picture from sample to sample to generate an enhanced output picture. The memory 14 in FIG. 1 can be removed from the architecture since a video sequence typically has a high correlation in temporal direction. In the description herein, the terms sample and pixel are used interchangeably and represent the same concept.

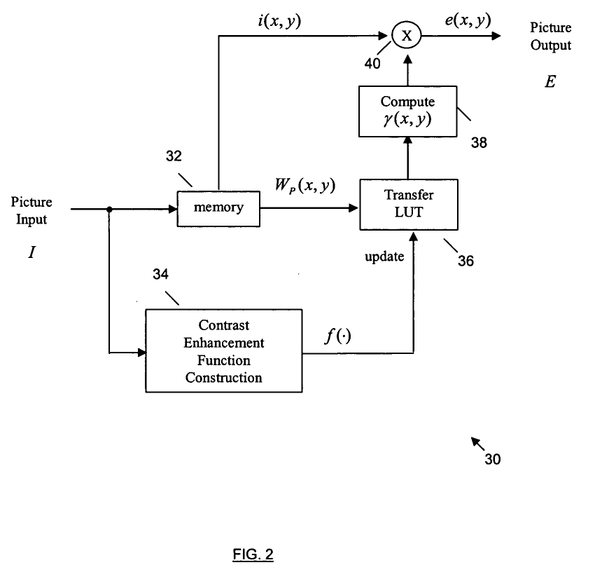

FIG. 2 shows a functional block diagram of an adaptive contrast enhancement (ACE) device 30 in accordance with an embodiment of the present invention. The ACE device 30 includes a memory 32, a Contrast Enhancement Function Construction (CEFC) block 34, a Transform LUT Construction block 36, a Transform Ratio Construction block 38 and a combiner node 40.

The Transfer LUT 36 represents a mapping table between input and output pixel values associated with the constructed contrast enhancement transform function f. The Ratio Construction block 38 then computes a locally smoothed transfer ratio by low pass filtering the transfer ratios of the input samples in the local window W_{P}(x, y). The locally smoothed transform ratio (average transform ratio), γ(x, y), is then multiplied to the input sample i(x, y). Example implementations are provided below.

In one example, the transform function f can be based on a probability density function (PDF) of a time varying input video sequence, wherein predetermined video parameters relating to contrast are extracted from the PDF. Based upon the extracted video parameters, a nonlinear transform function is then constructed and updated as the LUT, which can be synchronized with the associated video picture or field. The transform LUT is then applied to the input video in the functional block 36, to enhance the input signal.

The specific functional form of the transform function ƒ can change from picture to picture. Examples of constructing the transform function ƒ are provided in co-pending, commonly assigned, patent application Ser. No. 10/210,237, titled “Adaptive Contrast Enhancement Method For Video Signals Based On Time-Varying Nonlinear Transforms” (SAM2.008), filed Aug. 1, 2002, incorporated herein by reference. Other examples of computing fare provided in co-pending, commonly assigned, patent application Ser. No. 10/641,970, titled “Adaptive Contrast Enhancement Method For Video Signals Based On Time-Varying Nonlinear Transforms” (SAM2.0019), filed Aug. 15, 2003, incorporated herein by reference.

As noted, given a contrast enhancement function ƒ for picture enhancement, it is an object of the invention to provide a method which can reduce noise amplification. To do so, in an embodiment of the present invention the transform function is used to determine a transform ratio, and a spatially low-pass filtered transform ratio is then applied to the value of each pixel in the input picture for enhancing the picture while reducing noise amplification. In this manner, a human being cannot recognize that the noise in the input picture has been amplified. A fundamental notion behind the present invention is that the contrast between two samples “looks” the same if the same transform ratio is multiplied to the two samples. For example, to a human being, the visual difference (or contrast) between two sample values A and B would look the same as 1.5A and 1.5B.

Furthermore, if the local samples around a sample are processed with the same or similar transform ratio, it is expected that the noise visibility is not altered much. Hence, given a contrast transform function f, an object of the present invention is to effectively low-pass-filter the local sample conversion (transform) ratios, to provide locally constant conversion ratios in order to reduce noise amplification while enhancing contrast.

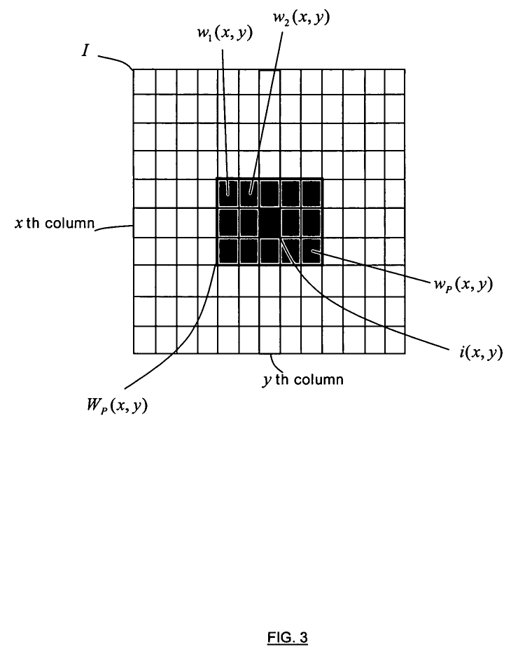

Several example implementations of determining the transform ratios are now described in conjunction with FIG. 3, wherein W_{P}(x, y) denotes a local sliding window in the input picture, containing P samples residing around the (x, y)^{th} sample having a sample value i(x, y), which is to be enhanced. The samples values in the sliding window W_{P}(x, y) are denoted as w₁(x, y), w₂(x, y), . . . , w_{P}(x, y), wherein wᵢ(x, y)=i(x+a, y+b) for proper values of a and b, and wᵢ(x, y)∈{0, 1, . . . , L}.

### FIRST EXAMPLE IMPLEMENTATION

In one example implementation, given a contrast enhancement function (i.e., transform function) f, an average transform ratio γ is determined as:

$$γ ( x , y ) = {\sum }_{i = 1}^{P} \frac{f ( {w}_{i} ( x , y ) )}{{w}_{i} ( x , y )} \cdot \frac{1}{P} \qquad ( 3 )$$

wherein ƒ(wᵢ(x, y)) is the output of the contrast enhancement function f for input samples wᵢ(x, y), such that

$$\frac{f ( {w}_{i} ( x , y ) )}{{w}_{i} ( x , y )}$$

represents the transform ratio for a sample wᵢ(x, y). Hence γ provides the average transform ratio,

$$\frac{f ( {w}_{i} ( x , y ) )}{{w}_{i} ( x , y )} ,$$

around the sample I (x, y).

The value of γ changes slowly across the input picture because of the low-pass nature of the averaging function in relation (3) above. As such, in an enhancement method according to the present invention, for a sample in the input picture, the neighboring samples have the same or similar transform ratio.

Accordingly, an example of suppressing noise amplification while enhancing the contrast is provided by:
e(x, y)=γ(x, y)·i(x, y) (4)
for all x=1, 2, . . . , N and y=1, 2, . . . , M

### SECOND EXAMPLE IMPLEMENTATION

In another example implementation, given a contrast enhancement function (i.e., transform function) f, the transform ratio γ is determined as:

$$γ ( x , y ) = {\sum }_{i = 1}^{P} \frac{f ( {w}_{i} ( x , y ) )}{{w}_{i} ( x , y )} \cdot {c}_{i} \qquad ( 5 )$$

where cᵢ are pre-determined constants satisfying

$${\sum }_{i = 1}^{P} {c}_{i} = 1 ,$$

and
e(x, y)=γ(x, y)·i(x, y) (6)
for all x=1, 2, . . . , N and y=1, 2, . . . , M

Note that relation (5) above is a generalized version of relation (3) above. By selectively adjusting the values of cᵢ, versatile suppression characteristics can be realized.

### THIRD EXAMPLE IMPLEMENTATION

In another example implementation, the transform ratio γ is determined as:

$$γ ( x , y ) = \frac{{\sum }_{i = 1}^{P} \frac{f ( {w}_{i} ( x , y ) )}{{w}_{i} ( x , y )} \cdot δ ( \vert i ( x , y ) - {w}_{i} ( x , y ) \vert )}{{\sum }_{i = 1}^{P} δ ( \vert i ( x , y ) - {w}_{i} ( x , y ) \vert )} \qquad ( 7 )$$

where
E(x, y)=γ(x, y)·i(x, y) (8)
for all x=1, 2, . . . , N and y=1, 2, . . . , M , wherein δ(|i(x, y)−wᵢ(x, y)|) is a weighting function of |i(x, y)−wᵢ(x, y)|, which can be defined in different forms depending on application. One example constraint on the weighting function is that δ(|i(x, y)−wᵢ(x, y)|) approaches 0 as the value of |i(x, y)−wᵢ(x, y)| increases, and δ(|i(x, y)−w,(x, y)|) approaches 1 as the value of |i(x, y)−wᵢ(x, y)| decreases to 0.

An example of δ(|i(x, y)−wᵢ(x, y)|) satisfying such constraint can be:

$$δ ( \vert i ( x , y ) - {w}_{i} ( x , y ) \vert ) = \{ \begin{matrix} 1 - \frac{\vert i ( x , y ) - {w}_{i} ( x , y ) \vert}{K} , & if \vert i ( x , y ) - {w}_{i} ( x , y ) \vert \leq K \\ 0 & else\end{matrix} . \qquad ( 9 )$$

The role of the weighting function is to take the transform ratios of the samples whose pixel values are close to i(x, y), into computation. In other words, if the pixel value of a neighboring pixel (wᵢ(x, y)) is too different from the sample value of the center sample (i(x, y)), then the transform ratio of such neighboring sample (wᵢ(x, y)) is excluded from the computation. Using the weighting function, the ratios are weighted smoothly depending on the difference sample value |i(x, y)−wᵢ(x, y)|.

Referring back to FIG. 2, the example ACE device 30 implements the methods in relations (3) through (9) above. Based on the contrast enhancement transform function ƒ from the CEFC block 34, the transform LUT is updated in the Transform LUT block 36 as:
LUT(k)=ƒ(k), for k=0, 1, . . . L. (10)

Then the transform ratio γ is determined in the block 38 according to one of relations (3), (5) and (7). Given the values of wᵢ(x, y) in relations (3), (5) and (7), where wᵢ(x, y)∈{0, 1, . . . , L}, then ƒ(wᵢ(x, y)) in those relations can be computed as LUT(wᵢ(x, y)).

To reduce computational complexity, according to an embodiment of the present invention, once the transform function ƒ is known, the ratio f

$$\frac{f ( {w}_{i} ( x , y ) )}{{w}_{i} ( x , y )}$$

in relations (3), (5) and (7) above can be pre-computed for all values of wᵢ(x, y), and stored in the LUT. Then the division operation in relations (3), (5) and (7) can be skipped. As such, the LUT is populated as:

$$LUT ( k ) = \frac{f ( k )}{k} , for k = 1 , 2 , … , L , \qquad ( 11 )$$

wherein relations (3), (5) and (7) can be simplified as:

$$\begin{matrix}γ ( x , y ) = {\sum }_{i = 1}^{P} LUT ( {w}_{i} ( x , y ) ) \cdot \frac{1}{P} , & ( 12 ) \\ γ ( x , y ) = {\sum }_{i = 1}^{P} LUT ( {w}_{i} ( x , y ) ) \cdot {c}_{i} , \\ and & ( 13 ) \\ γ ( x , y ) = \frac{{\sum }_{i = 1}^{P} LUT ( {w}_{i} ( x , y ) ) \cdot δ ( \vert i ( x , y ) - {w}_{i} ( x , y ) \vert )}{{\sum }_{i = 1}^{P} δ ( \vert i ( x , y ) - {w}_{i} ( x , y ) \vert )} , & ( 14 )\end{matrix}$$

respectively.

Then γ(x, y) is applied to the input signal using the combiner 40 (e.g., multiplication junction) to generate the enhanced output signal, with reduced noise amplification.

As such, in the example ACE device 30 in FIG. 2, the input picture is stored in the memory 32 while the transform LUT is constructed in block 34 using parameters obtained from the input picture. As noted above, the memory 32 is provided to delay the input video for one frame or field period so that the transform ratio can be applied to the picture that was used to construct the transform LUT. A video sequence typically has a high correlation in the temporal direction, and therefore, in most applications, the LUT transform that is constructed from one picture can be used for the subsequent picture in the video sequence. As such, in another example, the incoming picture is not stored while the transform LUT is constructed and the transform ratio is computed. The transform ratio that had been constructed from the previous picture in the video sequence is applied to this incoming picture. Similarly, the transform that is being constructed from this incoming picture will be used with the subsequent picture in the video sequence. Applying the transform ratio to the input picture is a pixel by pixel operation that outputs E(z) for the input pixel gradation level z.

The various components of the arrangements in FIG. 2 can be implemented in many ways known to those skilled in the art, such as for example, as program instructions for execution by a processor, as logic circuits such as ASIC, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method for adaptive contrast enhancement, comprising the steps of:
obtaining a video signal including a plurality of ordered digital pictures, each one of the digital pictures represented by a set of samples, each one of the samples having a gradation level;
constructing a contrast enhancement transform for enhancing the contrast of the video signal;
for each sample pixel of the video signal to be enhanced, computing transform ratios for neighboring samples based on the contrast enhancement transform; and
applying the transform ratio to the target sample representing a digital picture to enhance contrast of the digital picture with reduced noise amplification.

2. The method of claim 1, wherein the transform ratios for neighboring samples are within a predetermined range.

3. The method of claim 1, further comprising the steps of:
using the contrast enhancement transform to construct a look-up table for receiving sample values and for providing corresponding output values; and
computing the transform values by applying the look-up table to the neighboring samples, and thereby inherently applying the contrast enhancement transform to the neighboring samples to obtain transform values.

4. The method of claim 1, further comprising the steps of:
applying the contrast enhancement transform to the values of at least a plurality of the samples;
for each of the plurality of the sample values, determining an intermediate ratio of said sample value and the corresponding transform value;
using the intermediate ratios to construct a look-up table for receiving sample values and for providing a corresponding intermediate ratio value; and
for each sample in said set of samples, determining a transform ratio by applying the look-up table to neighboring samples, and thereby determining said transform ratios based on the intermediate ratios in the look-up table.

5. The method of claim 1, wherein computing a transform ratio for a target sample comprises the steps of:
applying the contrast enhancement transform to the values of at least the neighboring samples to obtain transform values; and
performing a low-pass averaging of the transform values to obtain said transform ratio.

6. The method of claim 1, wherein computing a transform ratio for a target sample comprises the steps of:
applying the contrast enhancement transform to the values of at least the neighboring samples to obtain transform values; and
determining the transform ratio based on the neighboring sample values, the corresponding transform values, and corresponding weighting factors.

7. The method of claim 6, wherein the weighting factor for each neighboring sample is a function of the difference in the target sample value and that neighboring pixel value.

8. The method of claim 7, wherein if the difference between the value of a neighboring sample and the value of the target sample is outside a selected range, then the corresponding weighting factor for that neighboring sample effectively excludes the transform ratio of that neighboring sample from determination of the transform ratio for the target sample.

9. The method of claim 1, wherein applying the transform ratios comprises the steps of multiplying each sample value of said set of samples with a corresponding transform ratio to enhance contrast of the digital picture with reduced noise amplification.

10. The method of claim 1, further comprising the steps of:
selecting the digital picture, which is enhanced when performing the step of enhancing the contrast, from a set of digital pictures including the first one of the digital pictures and one of the digital pictures that is temporally subsequent with respect to the first one of the digital pictures.

11. The method of claim 1, wherein the digital picture that is enhanced when performing the step of enhancing the contrast is an immediately temporally subsequent picture with respect to the first one of the digital pictures.

12. An adaptive contrast enhancement device for enhancing a video signal including a plurality of ordered digital pictures, each one of the digital pictures represented by a set of samples, comprising:
a transform constructor that generates a contrast enhancement transform for enhancing the digital picture;
a transform ratio generator that computes transform ratios based on the contrast enhancement contrast enhancement transform; and
a contrast enhancer that enhances contrast of the digital picture by applying the transform ratios to a set of samples representing a digital picture to enhance contrast of the digital picture with reduced noise amplification.

13. The device of claim 12, wherein the transform ratios for neighboring samples are within a predetermined range.

14. The device of claim 12, wherein the transform ratios for neighboring samples have essentially the same values.

15. The device of claim 12, wherein the transform ratio generator computes a transform ratio for a target sample by applying the contrast enhancement transform to the values of at least the neighboring samples to obtain transform values, and determining the transform ratio based on the transform values.

16. The device of claim 15, further comprising a look-up table constructed using the contrast enhancement transform, for receiving sample values and for providing corresponding output values;
wherein the transform ratio generator computes the transform values by applying the look-up table to the neighboring samples, and thereby inherently applying the contrast enhancement transform to the neighboring samples to obtain transform values.

17. The device of claim 12, further comprising a look-up table constructed by applying the contrast enhancement transform to the values of at least a plurality of the samples, and for each of the plurality of the sample values, determining an intermediate ratio of said sample value and the corresponding transform value, such that the intermediate ratios are used to populate the look-up table for receiving sample values and for providing a corresponding intermediate ratio value; and
wherein the transform ration generator is further configures to determine a transform ratio for s sample in said set of samples by applying the look-up table to neighboring samples, and thereby determining said transform ratios based on the intermediate ratios in the look-up table.

18. The device of claim 12, wherein the transform ratio generator computes a transform ratio for a target sample by applying the contrast enhancement transform to the values of at least the neighboring samples to obtain transform values, and determining the transform ratio based on the neighboring sample values and corresponding transform values.

19. The device of claim 12, wherein the transform ratio generator computes a transform ratio for a target sample by applying the contrast enhancement transform to the values of at least the neighboring samples to obtain transform values, and performing a low-pass averaging of the transform values to obtain said transform ratio.

20. The device of claim 12, wherein transform ratio generator computes a transform ratio for a target sample by applying the contrast enhancement transform to the values of at least the neighboring samples to obtain transform values, and determining the transform ratio based on the neighboring sample values, the corresponding transform values, and corresponding weighting factors.

21. The device of claim 20, wherein the weighting factor for each neighboring sample is a function of the difference in the target sample value and that neighboring pixel value.

22. The device of claim 21, wherein if the difference between the value of a neighboring sample and the value of the target sample is outside a selected range, then the corresponding weighting factor for that neighboring sample effectively excludes the transform ratio of that neighboring sample from determination of the transform ratio for the target sample.

23. The device of claim 12, wherein the contrast enhancer applies the transform ratios by multiplying each sample value of said set of samples with a corresponding transform ratio to enhance contrast of the digital picture with reduced noise amplification.

24. The device of claim 12, wherein the digital picture that is enhanced, is selected from a set of digital pictures including the first one of the digital pictures and one of the digital pictures that is temporally subsequent with respect to the first one of the digital pictures.

25. The device of claim 12, wherein the digital picture that is enhanced, is an immediately temporally subsequent picture with respect to the first one of the digital pictures.
